(19) United States
(12) Patent Application Publication
(10) Pub. No.: US 2014/0175267 A1
(43) Pub. Date: Jun. 26, 2014

(54) Method and Apparatus for Generation of Arbitrary Waveforms with Large Bandwidth and Long Time Apertures

(71) Applicants: Charles W. Thiel, Bozeman, MT (US); Peter B. Sellin, Bozeman, MT (US); Kristian D. Merkel, Bozeman, MT (US)

(72) Inventors: Charles W. Thiel, Bozeman, MT (US); Peter B. Sellin, Bozeman, MT (US); Kristian D. Merkel, Bozeman, MT (US)

(73) Assignees: MONTANA STATE UNIVERSITY, Bozeman, MT (US); S2 CORPORATION, Bozeman, MT (US)

(21) Appl. No.: 13/492,922

(22) Filed: Jun. 10, 2012

Related U.S. Application Data
(60) Provisional application No. 61/495,248, filed on Jun. 9, 2011.

(51) Int. Cl. G02F 1/35; G01J 1/42

(52) U.S. Cl. CPC G02F 1/353; G01J 1/42
USPC 250/216; 359/326

(57) ABSTRACT

Techniques for producing an arbitrary broadband waveform include storing a first waveform in a circulating coherent storage device. A next waveform is generated. A shifted replica is generated by shifting, by a frequency shift one of the next waveform or the waveform in the storage device. A combined waveform is stored by coherently combining the shifted replica and one of the next waveform or the waveform in the storage device which waveform is not frequency shifted. An apparatus includes a source of a carrier frequency waveform, and a modulator configured to impose the next waveform on the carrier frequency waveform. The apparatus also includes a circulating coherent storage device configured to store a coherent interaction between multiple waveforms. The apparatus also includes a frequency shifter configured to generate a shifted replica by shifting, by a frequency shift, one of the next waveform or a waveform in the storage device.

### CROSS-REFERENCE TO RELATED APPLICATIONS

This application claims benefit of Provisional Appln. 61/495,248, filed Jun. 9, 2011, the entire contents of which are hereby incorporated by reference as if fully set forth herein, under 35 U.S.C. §119(e).

### STATEMENT OF GOVERNMENTAL INTEREST

This invention was made with Government support under Contract No. W911NF-10-C-0015 awarded by the Department of the Army. The Government has certain rights in the invention.

### BACKGROUND OF THE INVENTION

Optical arbitrary waveform generation (OAWG) is a technique where a photonic device is programmed to create the desired output as an optical waveform which has an arbitrary modulation format that is user specified on demand. Typically this is done from a purely electronic approach, which is limited in bandwidth with a combined attribute of signal to noise ratio. OAWG has a wide range of potential and emerging commercial applications in both optical and electronic technologies.

### SUMMARY OF THE INVENTION

Electronic AWG systems meet the requirements of certain applications, but are typically limited in their combination of high bandwidth and high signal to noise ratio. Some optical AWG systems alleviate the limited bandwidth constraint. However, Applicants have recognized that, despite significant investment, the known state-of-the-art OAWG systems suffer from several limitations, including their relatively short duration for non-repetitive waveforms, a slow refresh rate, limited spectral resolution, and a relatively small number of independently controlled frequency channels

Applicants have determined that new OAWG methods are desired that are capable of effective use of wider bandwidth, extended time apertures, high-resolution spectral control of the optical waveforms, long optical coherence lengths, long-term absolute frequency stability, precise optical phase manipulation, or higher signal to noise ratio than electronic methods, alone or in some combination. Additional desirable properties identified by Applicants include systems that incorporate cost-effective low-bandwidth commercial technology with a robust, compact modular system design for efficient mass-production and deployment into a wide range of operation platforms.

In a first set of embodiments, a method for producing an arbitrary broadband waveform includes storing a first waveform in a circulating coherent storage device. A next waveform is generated. A shifted replica is generated by shifting, by a frequency shift, one of the next waveform or the waveform in the circulating coherent storage device. A combined waveform is stored by coherently combining the shifted replica and one of the next waveform or the waveform in the circulating coherent storage device which waveform is not frequency shifted. In some of these embodiments, the waveform in the circulating coherent storage device is frequency shifted by the frequency shift.

In another set of embodiments, a method includes determining a target broadband waveform. The method also includes determining a spectrum and phase for a first waveform in a circulating coherent storage device. The method further includes determining a spectrum and phase for a next waveform such that a frequency shifted replica of one of the first waveform or the next waveform coherently combined with one of the first waveform or the next waveform which is not frequency shifted generates a combined waveform that is stored in the circulating coherent storage device and that substantively matches at least a portion of the target broadband waveform.

In another set of embodiments, an apparatus includes a source of a carrier frequency waveform, and a modulator configured to impose the next waveform on the carrier frequency waveform. The apparatus also includes a circulating coherent storage device configured to store a coherent interaction between multiple waveforms. The apparatus also includes a frequency shifter configured to generate a shifted replica by shifting, by a frequency shift, one of the next waveform or a waveform in the storage device.

In another set of embodiments, an apparatus includes at least one processor and at least one memory including one or more sequences of instructions. The at least one memory and the one or more sequences of instructions are configured to, with the at least one processor, cause the apparatus to at least determine a target broadband waveform and a spectrum and phase for a first waveform and for a next waveform. The first waveform is for storage in a circulating coherent storage device. The determinations are made so that a frequency-shifted replica of one of the first waveform and the next waveform and a non-shifted waveform of the first waveform and the next waveform are coherently combined to generate a combined waveform that is stored in the circulating coherent storage device and that substantively matches at least a portion of the target broadband waveform.

In various other sets of embodiments, an apparatus or computer readable medium is configured to perform one or more steps of one or more of the above methods.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a high level block diagram of example components of an OAWG, according to one embodiment;

FIG. 2 is a block diagram of an OAWG system in which a control computer interfaces with photonic hardware to create user specified optical arbitrary waveforms, according to an embodiment;

FIG. 3 is a block diagram that illustrates an example basic regenerating optical ring for OAWG, according to an embodiment;

FIG. 4 is a block diagram that illustrates example spectral synthesis by accumulation of sequentially injected and frequency shifted pulses, according to an embodiment;

FIG. 5 is a block diagram of sequential steps involved in using coherent accumulation of many low-bandwidth frequency shifted pulses to generate a single high-bandwidth arbitrary optical waveform, according to an embodiment;

FIG. 6 is a table that illustrates example specifications for existing state-of-the-art laboratory demonstrations (see for example [ref. 7] and [ref. 14]) compared to example practical specifications for a new solution, according to an embodiment achievable with current components;

FIG. 7 is a high level block diagram that illustrates another implementation with additional advantages, according to an embodiment;

FIG. 8A, FIG. 8B and FIG. 8C are graphs that illustrate example synthesis of a 3.2 GHz waveform;

FIG. 9A, FIG. 9B, FIG. 9C and FIG. 9D are graphs that illustrate example pulses, according to various embodiments;

FIG. 10A, FIG. 10B and FIG. 10C are graphs that illustrate an initial demonstration of bipolar waveform synthesis for waveform specification (FIG. 10A) using a boosted optical level bias (unipolar optical power), and then a post-detection subtracted electronic offset via a biased-T junction;

FIG. 11 is a block diagram that illustrates a computer system upon which an embodiment of the invention may be implemented; and

FIG. 12 illustrates a chip set upon which an embodiment of the invention may be implemented.

### DETAILED DESCRIPTION

A method and apparatus are described for broadband optical arbitrary waveform generation (OAWG). In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention. References are indicated in the following by reference numbers, designated “ref #” or “refs #, #” (where # is a numeral between 1 and 14), which correspond to full citations as listed in a references section at the end of this description.

Some embodiments of the invention are described below in the context of arbitrary broadband optical waveforms. However, the invention is not limited to this context. In other embodiments, arbitrary waveforms of other portions of the electromagnetic spectrum, such as microwave waveforms or other radio frequency (RF) waveforms, are generated using steps and components known to correspond to those described below for optical waveforms. In some embodiments an optical waveform is converted to a voltage for output.

Some basic attributes of the desired waveform are wide bandwidth (BW) and its time aperture (TA). The metric of the time bandwidth product, or TBP=TA×BW covers both of these attributes. OAWG techniques can also be used to create radio frequency (RF), including millimeter wave (MMW), waveforms, a concept called herein RF-AWG. The approach is similar to OAWG but in which the output signal is a voltage, typically created by interacting the produced optical waveform with a photodetector, which converts photons to voltages. Thus, in some embodiments, an apparatus or system or method directs a combined waveform to an output channel and converts an optical waveform on the output channel to a voltage.

### 1. Overview

According to example embodiments described herein, wideband spectral shaping of optical signals with complete phase and amplitude control provides capabilities for generating complex waveforms that are difficult, expensive, or impossible to generate or transmit by purely electronic means [e.g., see refs 1, 2]. In various embodiments, the output is either an optical signal, or RF/MMW signals. Generation of agile, complex, wideband waveforms is useful for commercial applications including telecommunications and device test and measurement, optical code-division-multiple-access (CDMA) systems, synthetic aperture RADAR (SAR), unambiguous Range-Doppler radar or laser radar, and optical free space communications; and for scientific applications including pulse shaping for spectroscopy, among others [e.g., refs 3,4,5,6].

To meet new regimes of demanding performance targets, embodiments of enhanced OAWG systems are described herein, including an experimental prototype device embodiment. The approach is based on the coherent accumulation and interference of spectrally shaped waveforms. This represents a fundamental new direction in OAWG methodology—as this photonic approach is fundamentally different from other techniques that are known for the synthesis of wideband RF waveforms with photonic means [e.g., see refs. 7, 14]. A difference of the approach presented herein from other approaches is in the coherent waveform synthesis, in which the technique builds on a frequency and phase stable continuous wave (cw) laser and uses control signals derived from conventional, narrowband, and stable components (both modulators and electronics). The photonic components include a circulating coherent storage device, such as a coherent photonic storage ring apparatus with several control points. This is opposed to the prior art approach of modulating a train of brief optical pulses. The benefits in the new OAWG approach presented here include one or more of: full wideband operation of 10 gigahertz (GHz, 1 GHz=10⁹ Hertz, 1 Hertz=1 cycle per second) or higher; and a significantly increased time aperture of 1000 to 10000 times that of the prior art. For example, the time aperture scales to several microseconds (μs, 1 μs =10⁻⁶ seconds) or longer for one or more of the illustrated embodiments, as compared to a limit of several nanoseconds (ns, 1 ns=10⁻⁹ seconds) when using brief pulses.

The illustrated embodiments build on the concept of a spectrally accumulated signal in an optical storage ring. Some embodiments have focused on methods for generating accurate, broadband, rapid frequency chirps that span ranges approaching 1 terahertz (THz, 1 THz=10¹² Hertz). With further development, this same innovative technology is extended in other embodiments to generate arbitrary optical waveforms with complete amplitude and phase control over bandwidths of 1 GHz to 1 THz with spectral resolution down to ˜10 kilohertz (kHz, 1 kHz=10³ Hertz) and with time apertures of 1 to 100 μs. These are example ranges, and not intended to be limiting on either end of the scale.

An advantage of some embodiments includes operating with modern but rather ordinary photonic components such as those employed in telecommunications infrastructure. These components consist of lasers, fiber optics, low bandwidth modulators, low bandwidth control electronics, fiber optical amplifiers, and related fiber optical items (splitters, couplers, etc). This is an advantage in that the laser light can be formed arbitrarily wherever there are available components. Typically, this means that there is a good fit to the technologically significant 1.5 micrometer (μm, 1 μm=10⁻⁶ meters) wavelength telecommunications band, allowing the OAWG device to be constructed from high-quality commercial off-the-shelf components (COTS)—an important advantage for practical commercialization and mass-production of OAWG units. As used herein, waveform indicates any electromagnetic radiation comprising any combination of one or more frequencies, phases and amplitudes, including any or all of optical frequencies and radio frequencies.

### 2. Structural Overview

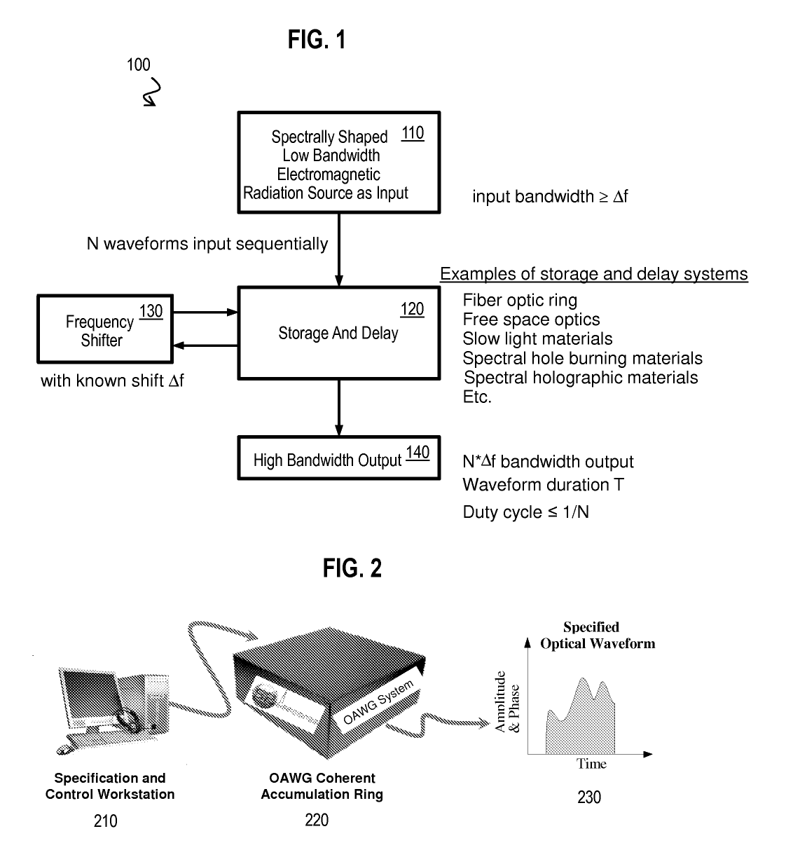

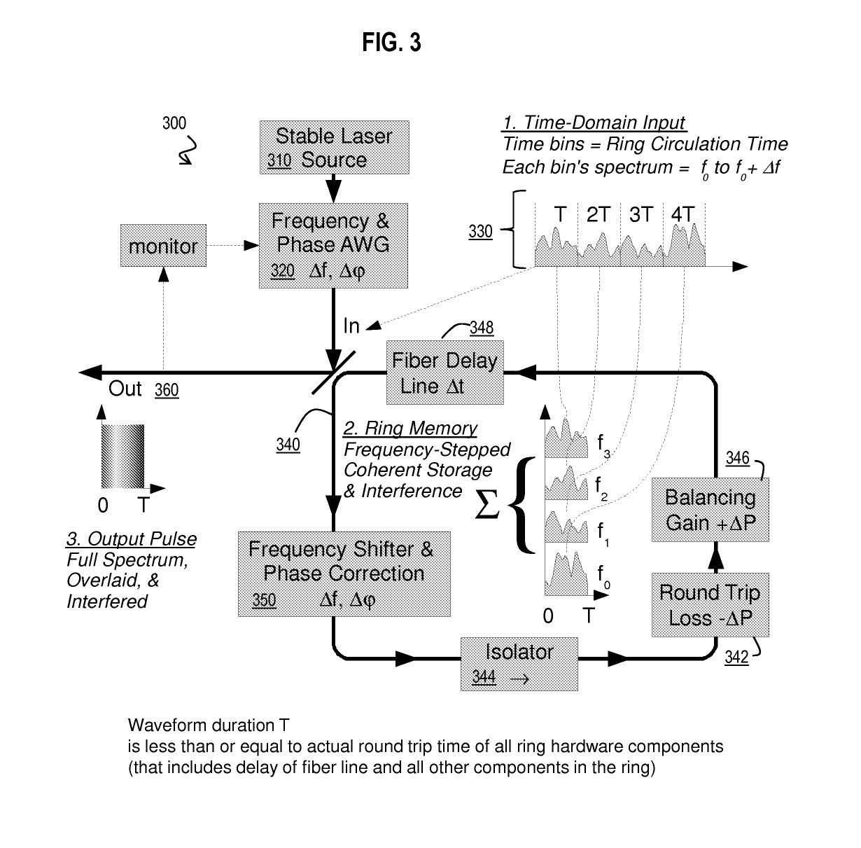

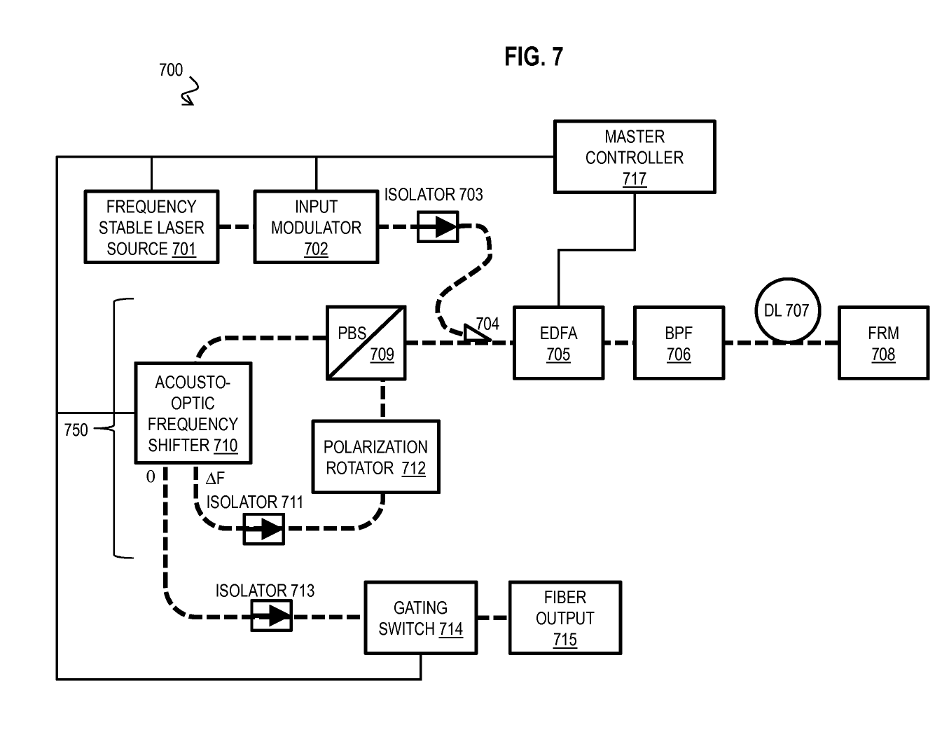

FIG. 1 is a high-level block diagram of example components of an OAWG 100, according to one embodiment. Each illustrated component of the OAWG device many be implemented in practice as any number of different specific embodiments that employ different specific component technologies, or combinations of technologies that fulfill the operational requirement of each illustrated conceptual element. Although processes, equipment, and data structures are depicted in FIG. 1 (and later diagrams, such as FIG. 2, FIG. 3 and FIG. 7) as integral blocks in a particular arrangement for purposes of illustration, in other embodiments one or more equipment, processes or data structures, or portions thereof, are arranged in a different manner, on the same or different devices, in one or more databases, or are omitted, or one or more different equipment or processes or data structures are included on the same or different devices. As shown in FIG. 1, the OAWG 100 includes a spectrally shaped, low bandwidth, electromagnetic radiation source 110, a circulating coherent storage device such as storage and delay device 120 to accumulate spectral input packets, a frequency shifter 130 that produces a known spectral frequency shift on all frequencies of the stored waveform (or the input waveform in other embodiments), and a high-bandwidth output coupler 140 to pass the accumulated waveform at either optical or microwave frequencies.

### 3. Operational Overview

The OAWG 100 is configured for one or more of the following operations. 1. Input source 110 is an electromagnetic radiation source. 2. Input source packets perform only lower bandwidth shaping as compared to desired output bandwidth of a target broadband waveform. 3. Input source provides a number (N) of limited bandwidth waveforms, called next waveforms herein, each individually spectrally configurable with lower bandwidth controls. 4. Each one of the N input waveforms of duration T (less than or equal to the entire hardware delay ring duration including the fiber delay line and all other ring components of storage and delay component 120) is input sequentially into the storage device. 5. Storage device 120 has intrinsic delay time that can store previous packets with a time aperture up to that delay duration. 6. Storage 120 is paired with a frequency shifter 130 that shifts previously input spectral packets to other frequencies to clear the spectral window for new inputs. 7. Storage device 120 includes methods to regenerate signal losses such as re-amplification or digital quantization and recovery. 8. A next input waveform is inserted into the next time slot and into the same frequency window as was occupied by the prior waveform (the prior waveform has just been frequency shifted into the next spectral window) to produce a combined waveform. 9. After N sequential cycles of input, the combined waveform in the circulating coherent storage device has accumulated and now contains up to N times the bandwidth of the original low bandwidth inputs. 10. After all inputs have been accumulated to produce a final combined waveform, the storage device outputs the combined waveform through an output coupler 140. 11. Output coupler 140 is capable of producing higher bandwidth modulation than was directly controlled by input sources 110. 12. Output on coupler 140 has up to a factor of N-times spectral enhancement factor above the input bandwidth that was implemented by input time division multiplexing and spectral accumulation designed to substantively match a target waveform. In this embodiment, a frequency band of the next waveform is narrower than a frequency band of the combined waveform. 13. Device 100 may accumulate broadband incoherent spectra with uncorrelated inputs from source 110. 14. Device 100 may accumulate broadband coherent spectra with phase-correlated inputs, phase stable storage during delay time, and precise synchronization of inputs with previously stored spectral content.

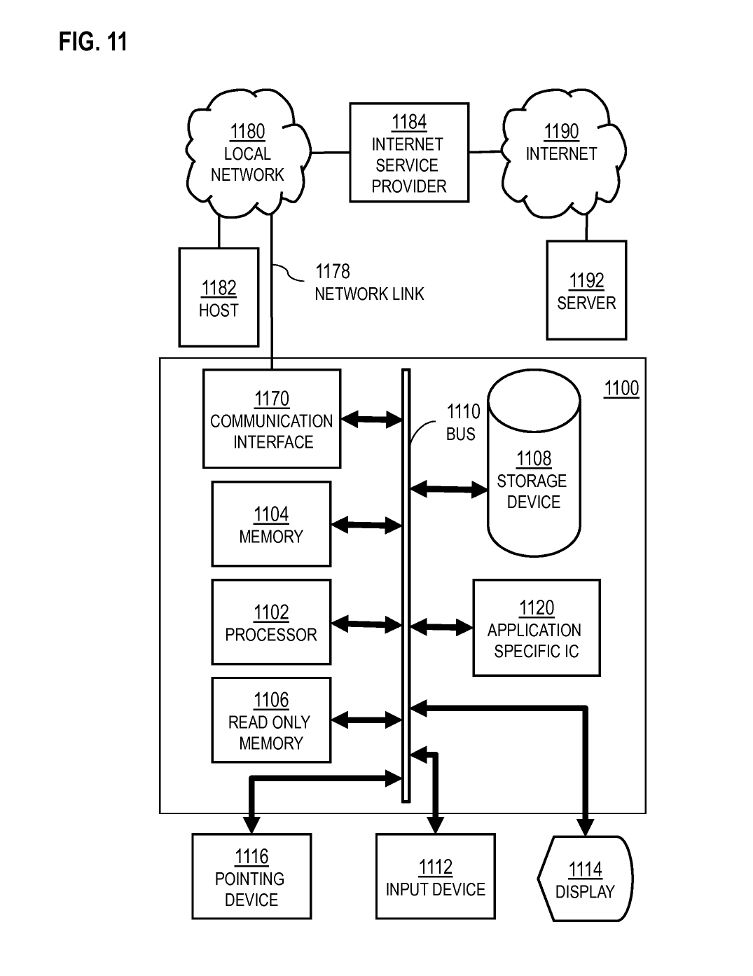

FIG. 2 is a block diagram of an OAWG system in which a control computer 210 interfaces with photonic hardware 220 to create user specified optical arbitrary waveforms 230, according to an embodiment. In this practical high-level industrial system embodiment, a master computer control workstation 210, as described in more detail below with reference to FIG. 11, electrically controls a photonics hardware package 220, with the result being an output combined waveform, such as an optical arbitrary waveform 230 emitted from the hardware 220 with a tailored time domain response substantively matched to a target waveform.

### 4. Example Embodiments

A first example embodiment for OAWG 100 provides complete and arbitrary control of optical amplitude and phase over the full output bandwidth in order to generate the target broadband waveform. This embodiment employs coherent light and a particular circulating coherent storage device that employs a regenerating optical ring that is designed to act as an optical time-to-frequency converter.

FIG. 3 is a block diagram that illustrates an example operation of a basic regenerating optical ring as the circulating coherent storage device for OAWG, according to an embodiment. In this embodiment, light from a frequency stable continuous wave laser source 310 is spectrally shaped by well-established methods using RF-driven optical modulators 320 to generate individual low-bandwidth, long time aperture next waveforms 330. These individual high-resolution next waveforms are then sequentially injected into a regenerating optical ring 340 where they are optically frequency shifted during each ring circulation by an element such as an intra-ring acousto-optical modulator (AOM) 350. Thus, a time-dependent input pulse is injected into the optical storage ring where it is coherently combined with a first waveform stored in the circulating coherent storage device, and the combined waveform is frequency shifted on each circulation. Coherent interference between sequentially injected input waveforms and the coherent light stored in the ring generates wideband optical combined waveforms at the ring output 360. Other components in the ring compensate for loss 342 and reflections. For example, isolator 344 ensures one propagation direction, balancing and gain components 346 compensate for loss 342 and fiber delay line 348 adds to the time aperture.

As additional phase-coherent next waveforms are sequentially injected into the optical storage ring, each waveform coherently interferes with the first waveform that comprises all the accumulated waveforms previously stored in the ring. Because of the repeated continuous optical frequency stepping added into the storage ring design, subsequent injected waveforms each span different sections of the optical spectrum, and the coherent interference of these stored waveforms generates the high-bandwidth optical arbitrary waveform output. After the desired spectral range is accumulated in the ring over a sequence of N low-bandwidth input cycles, the generated high-bandwidth optical waveform is coupled out of the ring. Thus, the combined waveform is directed to an output channel. After output, generation of the next waveform may begin, or the current waveform may be continuously repeated if desired, or circulated without additional frequency shifting. A modular delay line 348 inside the optical ring, such as a length of optical fiber, is employed to determine the time aperture of the output waveform, and an intra-ring optical amplifier 346, such as an erbium-doped fiber amplifier, compensates all losses incurred during circulation. Dynamic phase control of the signals in the storage ring can be enforced through elements within the storage ring, including, but not limited to: control of the electronic RF phase driving the intra-ring frequency shifter 350, incorporation of an intra-ring electro-optic phase modulator as part of component 350 or separately, or a mechanical fiber stretcher that alters the precise length of the optical delay line 348.

The fact that this simple and well-controlled method for constructing wide-bandwidth optical waveforms only requires low-bandwidth spectral shaping techniques acts as a tremendous advantage in design, construction, flexibility, and cost.

In other embodiments, the frequency shifter 350 (with or without phase correction) is applied to the next waveform before it is directed into the circulating coherent storage device. Thus, these embodiments show generating a shifted replica by frequency shifting, by a frequency shift, one of the next waveform or the waveform in the circulating coherent storage device; and storing a combined waveform by coherently combining the shifted replica and one of the next waveform or the waveform in the circulating coherent storage device which is not frequency shifted.

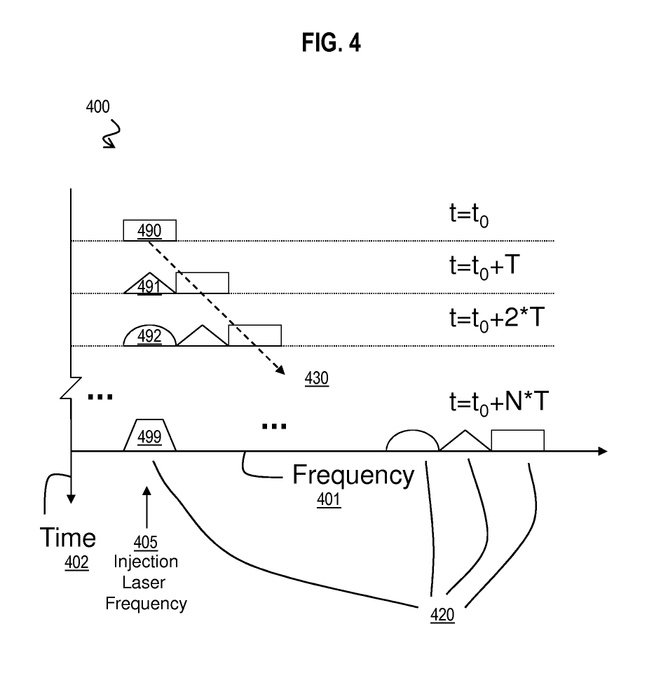

FIG. 4 is a diagram that illustrates an example of the synthesis of a completed waveform 420 that was created by the spectral synthesis process, depicted on an optical frequency axis 401 as it changes in time as indicated by snapshots in time displayed along a time axis 402. Each injected next waveform such as 490 at t=t₀, 491 at t=t₀+T, 492 at t=t₀+2T, etc, to 499 at t=t₀+N×T (implying N injections) are injected into the storage ring sequentially. The individual injected waveforms are each at the same injection laser frequency 405, although this is not required. The storage ring frequency shifts each and all previously injected waveforms that constitute a first stored waveform in the indicated frequency direction 430 to relocate them to other spectral regions, in order to empty a spectral region for the newest injected low-bandwidth waveforms. The end result final combined waveform has the spectrum 420 created by the accumulation of sequentially injected and frequency shifted waveforms, according to an embodiment.

This demonstrates storing a first waveform (e.g., 490) in a circulating coherent storage device; generating a shifted replica (e.g., 490 at time t=t₀+T) by frequency shifting, by a frequency shift (e.g., Δf=width of waveform 490), the waveform (e.g., 490) in the circulating coherent storage device. This also illustrates generating the next waveform (e.g., 491) and storing the combined waveform (490 and 491 at time t=t₀+T) by coherently combining the shifted replica (e.g., 490 at time t=t₀+T) and the next waveform (491) in the circulating coherent storage device. This also demonstrates repeating the steps of generating the frequency shifted replica (e.g., 490 and 491 at t=t₀+2*T), generating a next waveform (e.g., 492), and storing a combined waveform by coherently combining the shifted replica(e.g., 490 and 491 at t=t₀+2*T) and the next waveform 492 in the circulating coherent storage device.

In this example embodiment, each frequency shift is substantively equal to every other frequency shift; and, each of the next waveform and the first waveform is an optical waveform. Furthermore, in this embodiment, a frequency band of the next waveform (e.g., 492) is narrower than a frequency band of the combined waveform (e.g., 49 and 491 and 492).

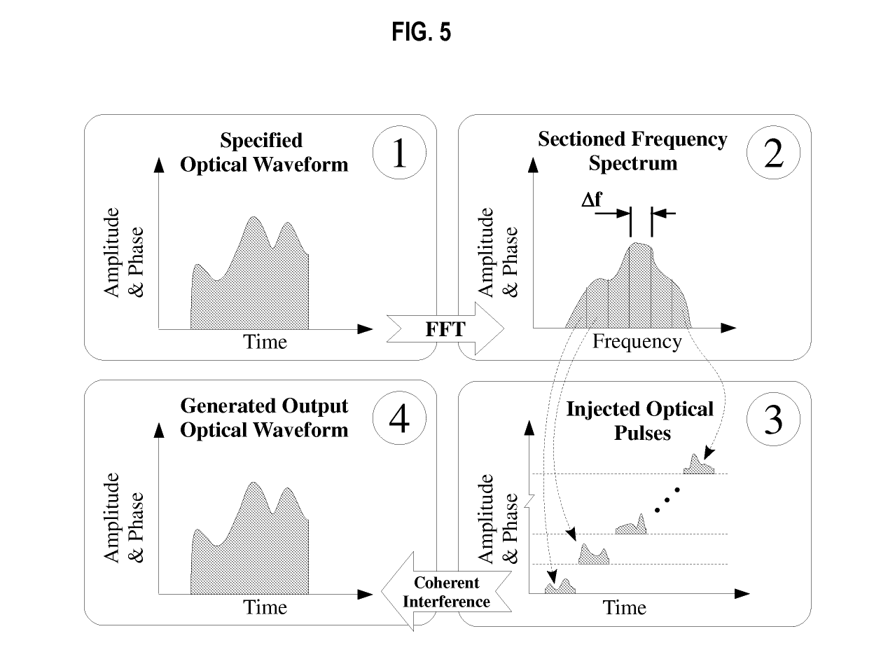

FIG. 5 is a block diagram of sequential steps involved in using coherent accumulation of many low-bandwidth frequency shifted pulses to generate a single high-bandwidth arbitrary optical waveform, according to an embodiment. Although steps are depicted in FIG. 5 as integral steps in a particular order for purposes of illustration, in other embodiments, one or more steps, or portions thereof, are performed in a different order, or overlapping in time, in series or in parallel, or are omitted, or one or more additional steps are added, or the method is changed in some combination of ways.

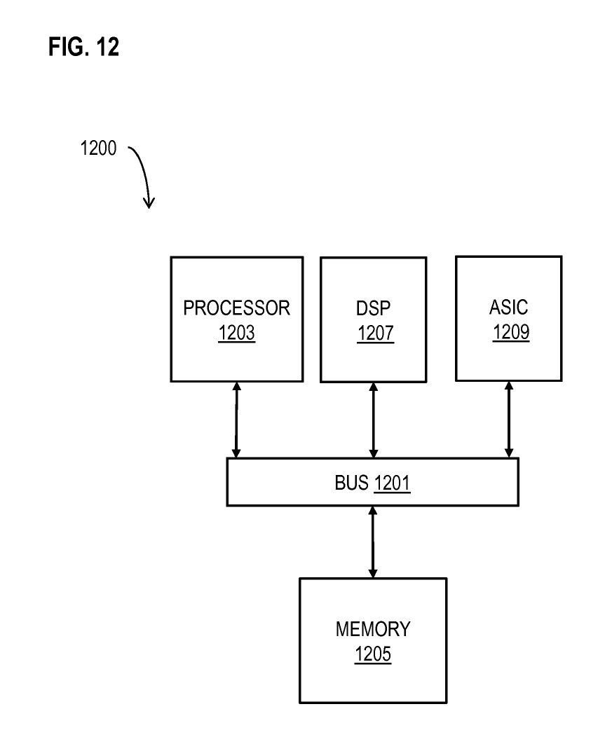

In the illustrated embodiment, Steps 1 and 2 are done a priori on an electronic computer or chip (as described below with reference to FIG. 11 and FIG. 12, respectively) with a computer based algorithm; while steps 3 and 4 are done in photonic hardware (e.g., as depicted in FIG. 3). The basic operational approach for constructing an arbitrary optical waveform with this accumulation method is diagrammed in FIG. 5. With Step 1, the desired target broadband optical waveform phase and amplitude profile are entered into a software interface. In Step 2, the computer calculates the Fourier spectrum of the desired high-bandwidth waveform and sections the spectrum into individual low-bandwidth frequency bins with width equal to or greater than the ring stepping frequency, depending on the specific embodiment. Thus, in step 1, a target broadband waveform is determined. In step 2,a spectrum and phase for a next waveform is determined and a spectrum and phase for a first waveform in a circulating coherent storage device is also determined. These are determined so that a frequency shifted replica of one of the first waveform or the next waveform coherently combined with one of the first waveform or the next waveform which is not frequency shifted generates a combined waveform that is stored in the circulating coherent storage device and that substantively matches at least a portion of the target broadband waveform.

During Step 3, these individual low-bandwidth sections of the spectrum are inverse Fourier transformed by the computer to generate low-bandwidth temporal waveforms that are then sequentially shaped and injected into the storage ring where they are frequency shifted on each circulation to cover the entire desired frequency bandwidth after a specified number of circulations. This leads to Step 4, where the coherent spectral interference of all the frequency-shifted low-bandwidth injected waveforms reconstructs the desired high-bandwidth optical waveform that is then coupled out of the ring on demand.

As evident in the above figures, these embodiments introduce a fundamental new direction in OAWG methodology: replacing the typical methodologies employed for OAWG, such as direct optical modulation or techniques of space-to-frequency conversion, with an entirely new approach of coherent spectral accumulation of sequentially generated low-bandwidth waveforms. This new concept provides unique advantages over all other OAWG methods due to the well-developed existing technological capability for controlling low-bandwidth waveforms in time.

There are several reasons why broadband optical arbitrary waveform generation in a re-circulating optical storage ring can achieve more precise waveform synthesis than what is possible with other methods such as the current state-of-the-art method of spectral line-by-line filtering of the comb emission spectrum of a mode-locked laser. A self-referenced optical frequency comb [e.g., see ref. 9] can emit a set of very broadband frequency components that can be individually manipulated for waveform synthesis. These systems generally employ dispersive elements to spatially separate the spectral components onto a spatial light modulator (SLM) that allows the phase and amplitude of each spectral component to be manipulated. In the current state-of-the-art OAWG systems, individual phase-locked spectral lines of the optical frequency comb are imaged onto independent pixels of the SLM to allow for spectral resolutions limited only by the mode-locking frequency [e.g., see refs 10, 11, 12]. While these systems provide excellent capabilities for generating waveforms with bandwidths of THz or more, there are significant limitations in present day filtering technologies for how precisely the desired spectrum can be shaped after spatial separation by a diffraction grating or other methods.

Recent SLM demonstrations [e.g., see ref. 13] for arbitrary waveform shaping have used on the order of 10² elements (perhaps extensible to 10³) to control the entire bandwidth of the input optical frequency comb with available sizes of optical phase and intensity modulator arrays, such as transmissive liquid crystal display (LCD) pixel arrays. This restrictive limitation on the number of independent spectral data bits directly translates to limited dynamic range and waveform shaping capabilities. Furthermore, current SLM technology based on thermo-optic effects or LCD arrays is limited to slow refresh rates of a few kHz, at most. In addition, practical frequency mode spacings are limited to MHz to GHz ranges, limiting the non-repetitive waveform time apertures to less than microseconds, and more typically to nanoseconds or picoseconds. While a variety of techniques may be employed to spread the discreet spectral elements continuously over the spectrum, the spacing of SLM pixels still sets the ultimate frequency resolution.

Various illustrated embodiments for OAWG through coherent accumulation provide many unique advantages over traditional methods of spectral shaping of frequency combs. These advantages arise through the approach of using a highly stable cw laser source with a frequency stepping optical storage ring as an effective time-to-frequency converter, allowing all of the spectral shaping to be performed in the time domain. With this technique, time can be mapped to frequency with any chosen proportionality so that individual sections of the final frequency spectrum may be shaped with a spectral resolution and bandwidth chosen to match available low-cost COTS RF frequency opto-electronic components. Furthermore, the ultimate non-repetitive length of the time aperture is only limited by the optical fiber delay line in the storage ring, which can be greater than 100 μs using conventional fiber optic cable as the delay line and optical amplifiers to overcome the loss in the fiber. As a result, complete and continuous spectral shaping across a bandwidth of up to 1 THz is possible with resolutions of 10 kHz, corresponding to phase and amplitude control of 10⁸ independent spectral channels—a capability clearly far advanced of the 100-1000 channels available with SLM technology.

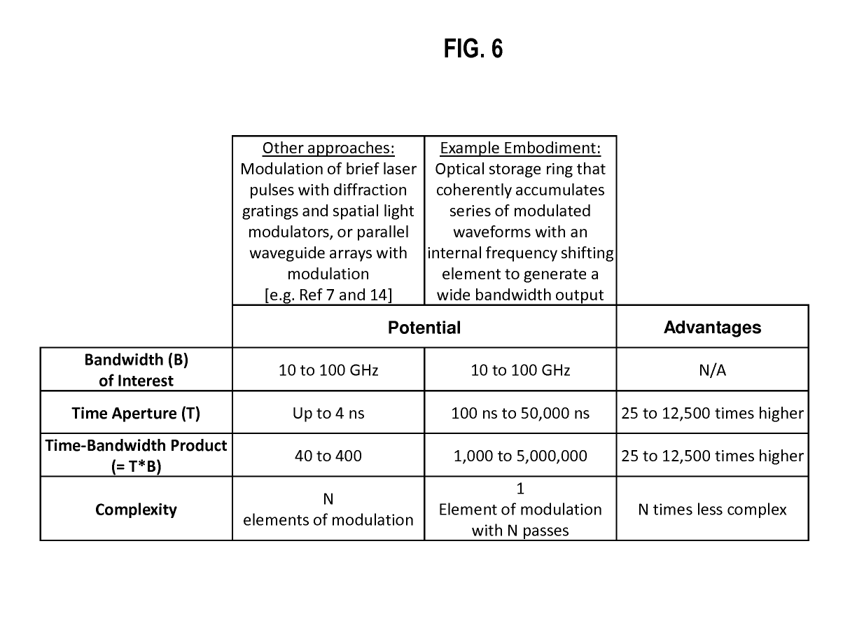

FIG. 6 is a table that illustrates example specifications for existing state-of-the-art laboratory demonstrations (e.g., see [ref.7] and [ref. 14]) compared to example practical specifications for a new solution, according to an embodiment achievable with current components. Prior approaches are capable of a bandwidth of about 10 to about 100 GHz, a time aperture of about 4 nanoseconds (ns, 1 ns=10 ⁻⁹ seconds), a time-bandwidth product of about 40 to about 400 and involve a complexity of N elements of modulation, where N is the number of waveforms combined to produce an arbitrary waveform. In contrast, example embodiments described herein demonstrate a bandwidth also of about 10 to about 100 GHz, but a longer time aperture of about 100 ns to about 50 μs, a much larger time-bandwidth product of about one thousand to about five million and involve a complexity of only one element of modulation regardless of the size of N. The advantages of such embodiments include a factor of 25 to 12,500 greater time aperture and time bandwidth product, and a factor of N less complexity.

While there are many different embodiments anticipated, one embodiment for generating high bandwidth phase and amplitude controlled output optical waveforms is depicted in FIG. 7. FIG. 7 is a high-level block diagram 700 that illustrates another implementation with additional advantages, according to an embodiment. The embodiment of FIG. 7 involves one or more of the following: frequency stable, narrow linewidth laser source 701, for example an optical fiber laser source; high dynamic range optical input modulator 702, having attributes of being able to modulate light in amplitude and either phase or frequency for input waveform shaping, for example waveguide amplitude modulation (AM) and phase modulation (PM) modulators, acousto-optic modulators (AOMs), or single-sideband suppressed carrier modulators (SSCMs); an optical isolator 703 configured to enable one way propagation of light; an optical coupler 704 configured to inject input waveforms into circulating coherent storage device 750 with a frequency shifter 710. For example, the circulating coherent storage device 750 includes a ring comprising a fiber-optic beam splitter; a linear optical amplifier, for example an erbium-doped fiber amplifier (EDFA) 705; an optical bandpass filter (BPF) 706 for passing the accumulating optical spectrum while blocking out-of-band optical amplifier noise such as amplified stimulated emission from the EDFA; an optical delay line (DL) 707, for example a length of single-mode optical fiber or a free space path; a Faraday rotation minor (FRM) 708 for reflecting the accumulated waveform back through the described path with a conjugate polarization, so that the fiber DL, the BPF and EDFA are used twice, and the waveform can propagate through the ring, delay for another recirculation and into the subsequent components with the appropriate polarization; a polarizing beam splitter (PBS) 709 acting with the FRM as an optical circulator to transfer light to and from the unidirectional part of this embodiment of the ring; an optical frequency shifter 710 in the storage ring, for example an acousto-optic frequency shifter; an isolator 711 configured to enable one way circulation of light in this embodiment; a polarization rotator 712 to allow the light to be transferred by the PBS towards the EDFA. Constant relative phase-lock of input laser optical frequency, optical frequency shifter, and optical storage ring circulation frequency (inverse of round trip circulation time period) can be achieved with precise system timing for all electronic and optical signals, such as stable pulse generators or master system clock in a master controller 717 for all electronic components. The output of the device in this embodiment is achieved by using the non frequency shifted arm of the acousto-optical frequency shifter 710, other methods are possible that include any other standard light pick off device, fiber or free space (collectively called an output coupler); the output then passes thru an isolator 713; a gating switch 714, such as a acousto-optical modulator, or other device; and a fiber output 715. The embodiment depicted in FIG. 7 has the additional advantage that the system may be optionally implemented with all fiber-optic coupled components for optical path length stability, reduced complexity in assembly and alignment, low cost, and ease of packaging.

### 5. Experimental Results

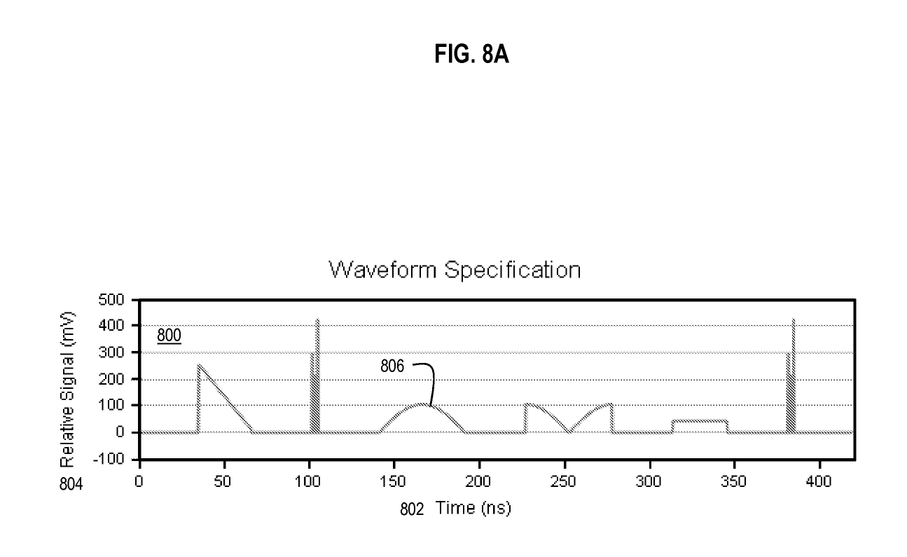

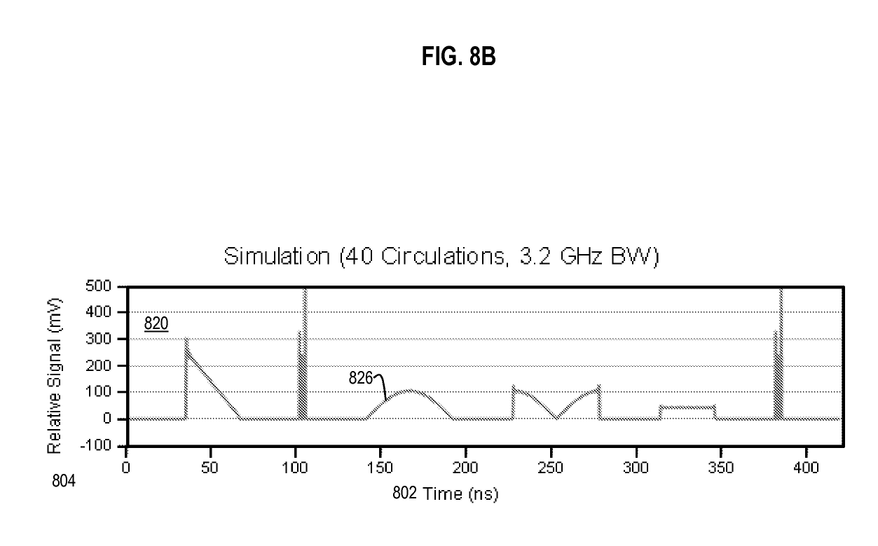

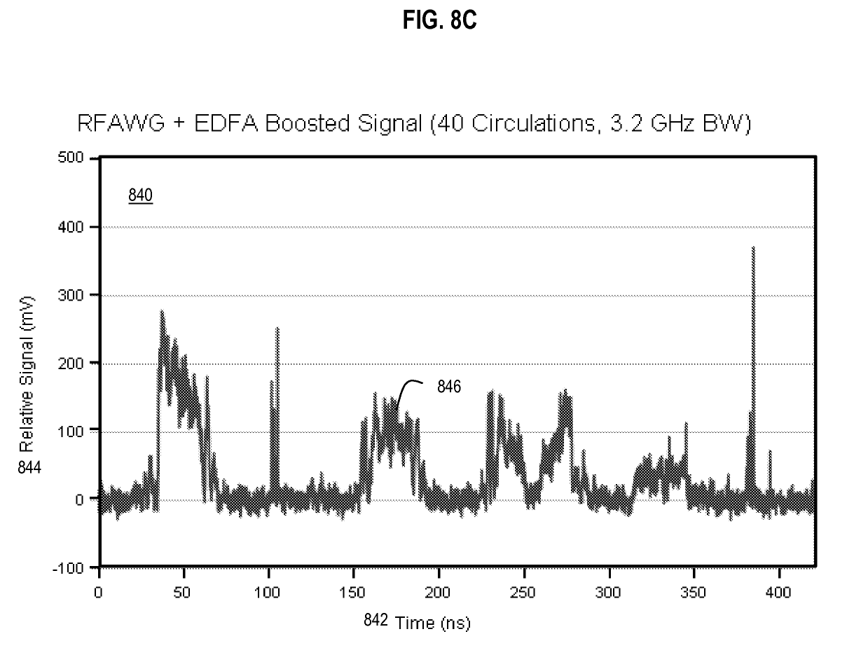

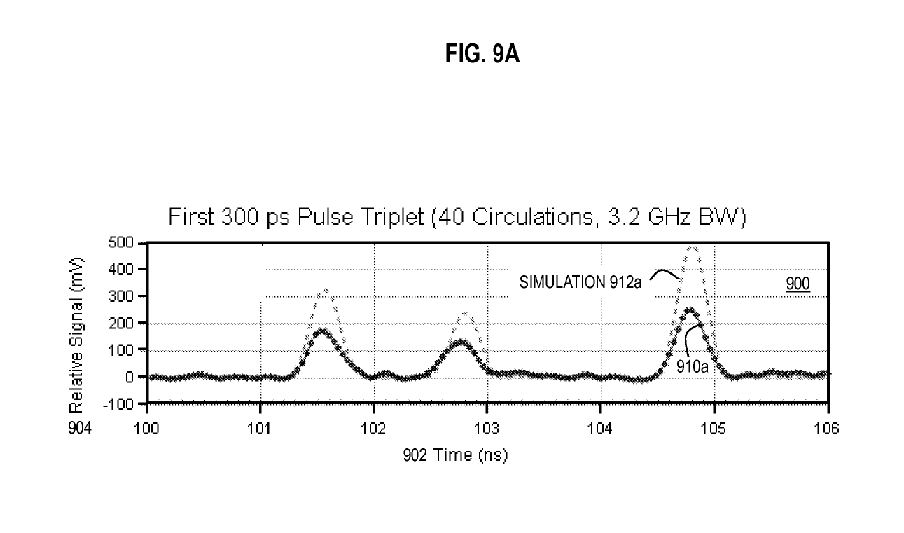

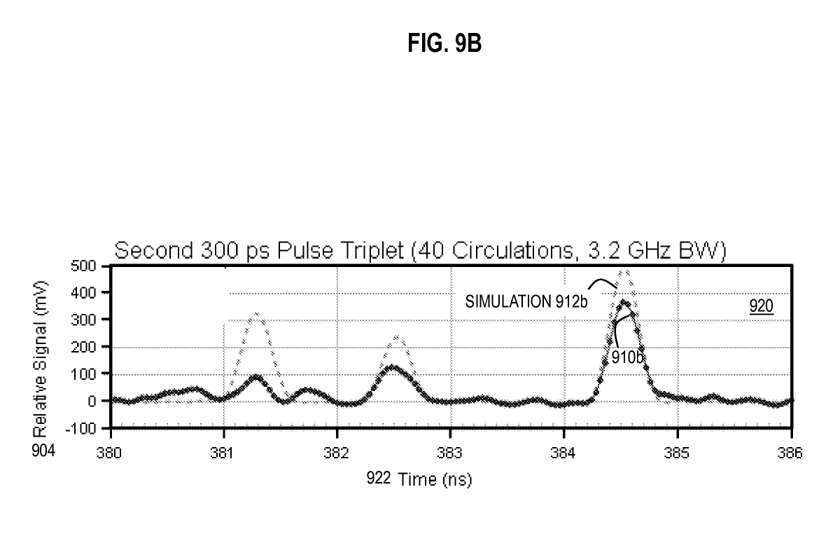

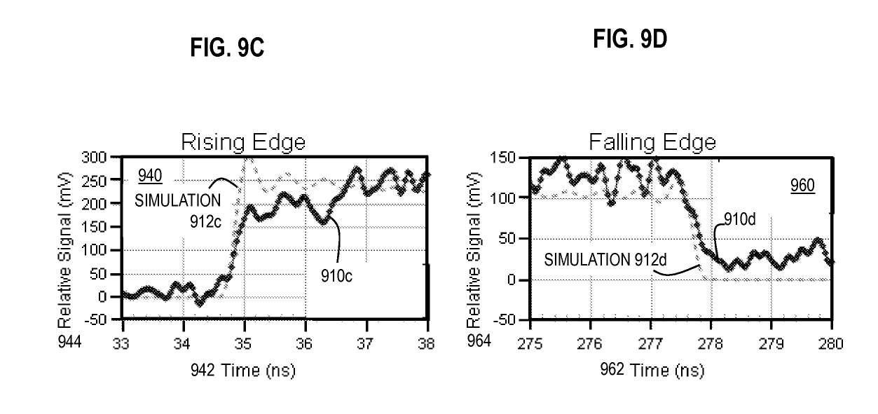

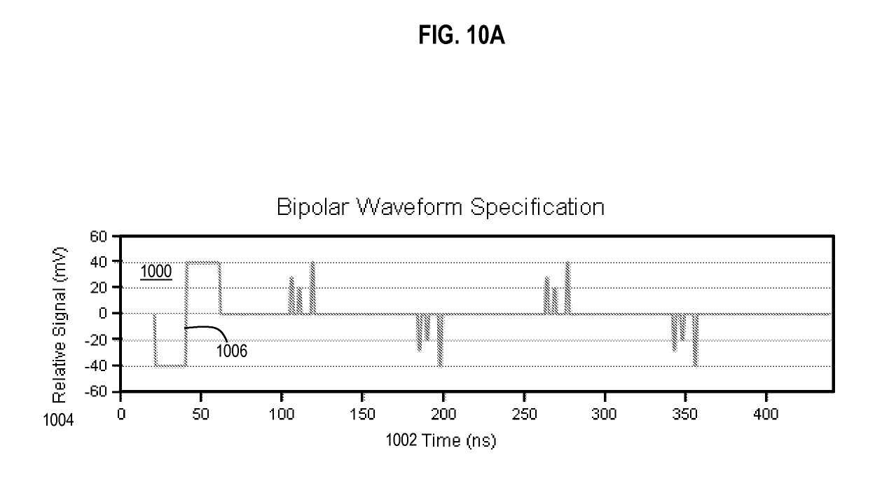

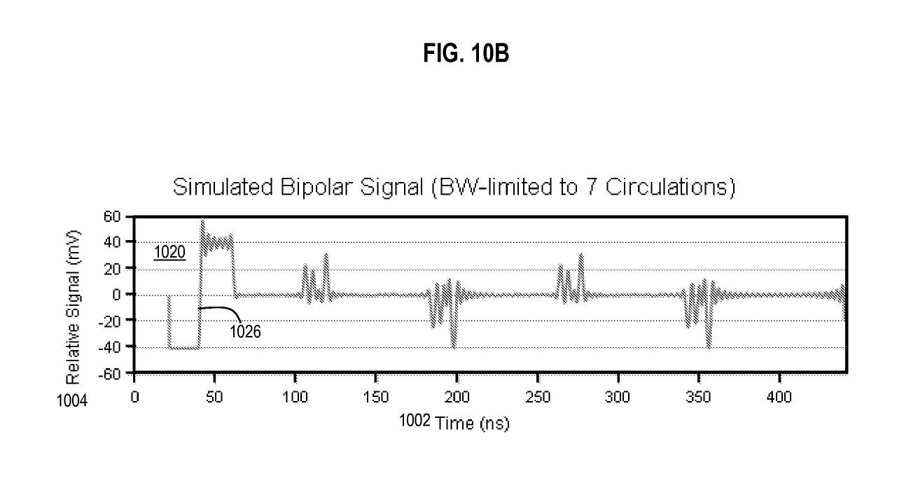

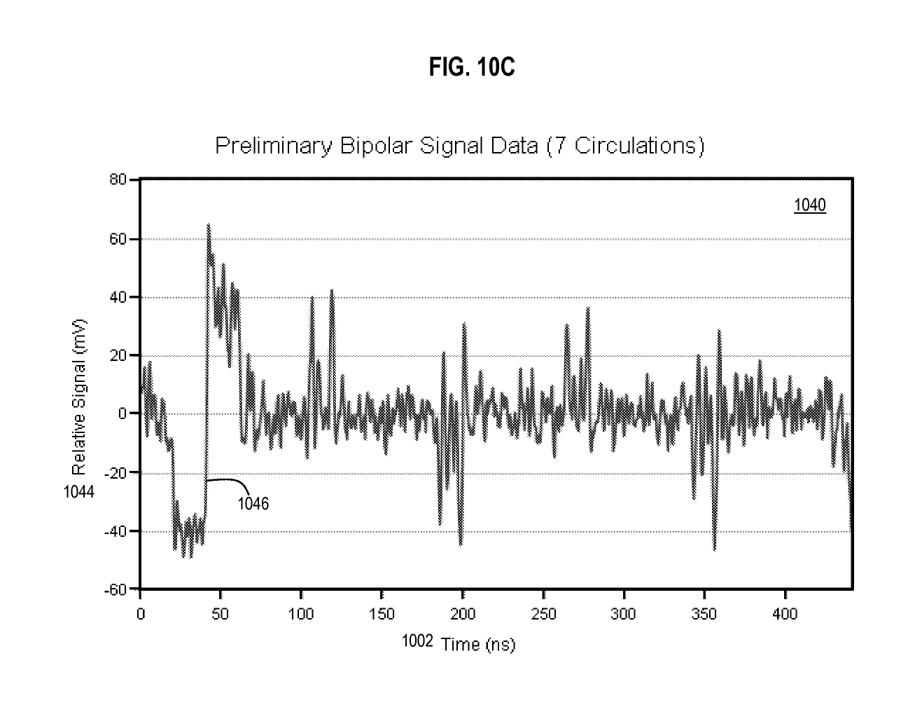

The high-level design of the embodiment depicted in FIG. 7 was implemented and used to produce experimental results. Commercial off-the-shelf (COTS) optical components at 1.5 micron optical telecommunications wavelengths were used. Results of these proof of principle demonstrations are shown below in FIG. 8, FIG. 9 and FIG. 10. These results are very promising and demonstrate that this approach is practical with existing COTS components.

### 5.1 RF-AWG at 3.2 GHz Bandwidths, 420 ns Time Aperture, and TBP=1146

Some embodiments involve an RF output waveform rather than an optical output waveform, called herein “photonics-enabled Radio-Frequency Arbitrary Waveform Generation” (RF-AWG). Development efforts for such embodiments are summarized below.

This demonstration illustrates embodiments capable of high-speed RF waveform synthesis at the expected 3.24 GHz of bandwidth can be measured using present equipment. The highest bandwidth waveforms were synthesized by embodiments using forty circulations in the optical storage ring (e.g., N=40 low-bandwidth signal accumulation cycles), with frequency shifts of 80.993 MHz on each storage ring circulation, producing a total output signal bandwidth of 3.24 GHz. The forty low-bandwidth input waveforms each were shaped with a bandwidth of 80.993 MHz using optical fiber-coupled waveguide AM and PM modulators driven by an electronic AWG. The created waveform fills approximately 350 ns of the full 419.79 ns time aperture, for a demonstrated time bandwidth product (TBP) of 1,134.

FIG. 8A, FIG. 8B and FIG. 8C are graphs that illustrate example synthesis of a 3.2 GHz waveform: FIG. 8A is a graph 800 that depicts an arbitrary waveform specification; FIG. 8B is a graph 820 that depicts a simulated output of forty accumulations; and, FIG. 8C is a graph 840 that depicts experimental data. The target broadband waveform specification is depicted in FIG. 8A as trace 806. The horizontal axis 802 is time in nanoseconds and the vertical axis 804 is relative signal strength in millivolts (mV, 1 mV=10 ⁻³ volts). The features of trace 806 were selected to have both low and high bandwidth components. Graph 800 shows that any mix of desired waveforms can be specified by programming them as one-dimensional arrays of amplitudes and phases in the control computer's waveform partitioning software. The large, geometrical shapes are quicker and easier to visually interpret than irregular bit-streams, and they also provide for inspecting longer timescale signal continuity. Higher bandwidth features can be seen in two embedded repetitions of the previously demonstrated three-bit pattern, as well as by studying the reproduction of the sharp vertical edges of the larger shapes.

FIG. 8B is a graph 820 that depicts the simulated interference as trace 826 that is computed by the computer program that also generates the forty low bandwidth injection waveforms. The horizontal axis 802 is time in nanoseconds and the vertical axis 804 is relative signal strength in millivolts. The assumptions of the simulation are that the phase and amplitude profiles of the injected waveforms are undistorted, the injection timing is perfect, and there is no noise in the system. At 3.24 GHz of bandwidth, the edges are quite sharp. Small damped transient oscillations after large changes occur only as a consequence of specifying the target waveform with infinite bandwidth while limiting the bandwidth of the simulated output to 3.24 GHz.

The entire experimental data trace 846 for the full time aperture is shown in graph 840 of FIG. 8C. The horizontal axis 842 is time in nanoseconds and the vertical axis 844 is relative signal strength in millivolts. The optical output of the storage ring was boosted by an EDFA, the amplified signal was detected by a photo-receiver with DC to 12 GHz response, and recorded on a 3 GHz and 10 gigasamples per second (GS/s, 1 gigasample, GS,=10⁹ samples) real-time oscilloscope (Tektronix TDS694C). No averaging or other filtering was used.

FIG. 9A, FIG. 9B, FIG. 9C and FIG. 9D are graphs that illustrate example pulses, according to various embodiments. These pulses are shown in more detail to illustrate that the synthesis is using the full 3.24 GHz net bandwidth of the forty injections. FIG. 9A is a graph 900 that illustrates a detail of three brief data pulses with varied amplitude at 100 ns to 106 ns. The horizontal axis 902 is time in nanoseconds and the vertical axis 904 is relative signal strength in millivolts. FIG. 9A shows a portion 910a of 300 ps wide pulses and a portion 912a of a simulation of the perfect response. FIG. 9B is a graph 920 that illustrates detail of the second group of data pulses at 380 ns to 386 ns. The horizontal axis 902 is time in nanoseconds and the vertical axis 904 is relative signal strength in millivolts. FIG. 9B shows a portion 910b of 300 ps wide pulses and a portion 912b of a simulation of the perfect response. FIG. 9C and FIG. 9D are graphs 940 and 960, respectively, which illustrate details of rising and falling edges at 35 ns and 278 ns, respectively. In FIG. 9C, the horizontal axis 942 is time in nanoseconds and the vertical axis 944 is relative signal strength in millivolts. In FIG. 9D, the horizontal axis 962 is time in nanoseconds and the vertical axis 964 is relative signal strength in millivolts. FIG. 9C shows a portion 910c of 300 ps wide pulses and a portion 912c of a simulation of the perfect response. FIG. 9D shows a portion 910d of 300 ps wide pulses and a portion 912d of a simulation of the perfect response. The measured response is hereinafter referenced as response 910 and includes trace portions 910a, 910b, 910c and 910d. The simulated response is hereinafter referenced as simulation 912 and includes simulation trace portions 912a, 912b, 912c and 912d

The peaks of trace 910 occur with the correct timing; however, the amplitudes for the finer features are below that projected by the “perfect” simulation trace 912 indicated by dashed curves. The simulation trace 912 was scaled to best fit the larger shapes in the waveforms, which was effectively averaged by observing a longer duration for that waveform. Variations on the faster peaks could be due to phase noise on any of the circulations that might partially disrupt the coherent interference of all the injections of the many spectral bands that is needed for full peak amplitude reconstruction. Similarly, the fast rising and falling edges have the wide spectral content of many circulations and exhibit noise after the most rapid part of the peak edge.

In this initial proof-of-principle embodiment, phase noise in the passive storage ring impairs the circulating reconstruction fidelity. This effect may be improved in other embodiments by actively or passively stabilizing the optical storage ring.

### 5.2 Embodiment for Bipolar RF Signal Generation & Demonstration

Some embodiments are designed for achieving bipolar radio frequency (RF) signal generation. Therein, the photodetector is a current source input to a high bandwidth Bias-T with direct current (DC) throughput of a configurable fixed offset current added to the detected photocurrent, with the combined signal then sent through a resistive load. This allows the photocurrent to be operated at a nominal half-maximum level for zero signal that is offset above and below that level for positive and negative signals, respectively.

An initial demonstration was performed for synthesizing bipolar electronic waveforms by using the previously suggested technique. FIG. 10A is a graph 1000 with horizontal axis 1002 indicating time in nanoseconds and a vertical axis 1004 indicating relative signal strength in millivolts. Trace 1006 indicates the target waveform. FIG. 10B is a graph 1020 with horizontal axis 1002 indicating time in nanoseconds and a vertical axis 1004 indicating relative signal strength in millivolts. Trace 1026 indicates the simulated waveform. FIG. 10C is a graph 1040 with horizontal axis 1002 indicating time in nanoseconds and a vertical axis 1044 indicating relative signal strength in millivolts. Trace 1046 indicates the actual waveform measured at output of the system of FIG. 7.

FIG. 10A, FIG. 10B and FIG. 10C illustrate an initial demonstration of bipolar waveform synthesis for waveform specification (FIG. 10A) using a boosted optical level bias (unipolar optical power), and then a post-detection subtracted electronic offset via a biased-T junction. With the limited bandwidth of only seven circulations, there are comparable transients observed in both simulation (FIG. 10B) and data (FIG. 10C).

An input waveform is specified as shown in FIG. 10A. This bipolar RF signal is temporarily converted to an equivalent unipolar signal by adding a half-maximum offset as a DC bias level, so that it is implemented as a simple unipolar power envelope for handling by the optical interference process steps in some embodiments. After the AC-coupled photodetector transfers the optical envelope to an RF signal, a bias-T junction subtracts a fixed DC current to remove the preset optical bias level in these embodiments. The resulting current is passed through a resistive load (or alternatively through a transimpedance amplifier). The end output is a bipolar voltage waveform for the user.

The idea for creating “bipolar” optical waveforms biased at half optical intensity (for making bipolar RF signals via a post-photodetection subtracted offset) may be difficult to implement in some embodiments because the optical dynamic range is limited by the large average “DC” component. More sophisticated strategies for dynamic range preservation are used in yet other embodiments, such as by employing compression with non-linear absorbers and non-linear re-amplification or electronically combining opposite polarity signals from two independent systems.

Preliminary data from initial embodiments is shown in FIG. 10C. In this embodiment, the optical waveform representation is broken down into seven injections comprising a total of 567 MHz of bandwidth for this data. The time aperture is 419.79 ns, and the resulting TBP was about 238. What is remarkable is that many of the transient oscillations that are most easily seen in the simulated trace of FIG. 10B are also quite visible as very similar mid-level oscillations in experimental data of FIG. 10C, indicating that these undulations are not random noise.

### 6. Applications

The example optical arbitrary waveform generation devices (OAWG) serve applications grouped in two primary divisions: a) usage as a primary optical arbitrary waveform source, and b) usage for conversion of the optical waveform modulation to RF for the generation of 10 GHz-100 GHz bandwidth signaling. One goal is for a portable, rugged photonic hardware system. Such OAWG embodiments are deployable for a variety of applications, in typical test and measurement packaging. Thus, applications can be divided into photonic outputs and RF outputs.

As one example of optical source market demand, the OAWG product provides an enabling component for the ultra-wideband signal processing capabilities of an optical LADAR/communications system. This high spectral resolution is preferred for optical synthesis of wideband RF waveforms or generation of complex and agile optical waveforms for LADAR. Other capabilities can process UWB optical waveforms, and thus the OAWG embodiments are enabling for generating optical arbitrary waveforms, which are then optically processed.

Examples of applications using OAWG photonic outputs are: 1) a fundamental signal generator for photonic circuitry test and measurement to fill the unpopulated gap for 10 GHz-1 THz optical modulation sources; 2) optical analog to digital converter (ADC) systems, as described above; 3) LADAR with spectrally tuned and customized waveforms for maximum return for each situation; 4) LADAR vibrometry with extended range returns of the time aperture in the OAWG, where individualized analysis waveforms can be sequentially applied to each specific spectral return blip from a multiple vehicle return signal; 5) compressed optical communication streams using brevity and high bandwidth to compact the data for assisting in low probability of intercept communications; and 6) heterodyne detection using AWG for coherent detection, particularly with spectral compression for acquisition of sparse waveforms with spectral energy allocation directed to bandwidths of particular interest.

The application of OAWG as an input to the conversion interface for ultra-high speed RF applications is very similar but with the end result being a voltage signal. The RF applications often involve development of a specialized RF backend, with a wideband photo-detector and amplifiers. This may be of particular interest for users or companies already possessing those capabilities. Applications include: 1) electronic countermeasures where incoming signals are jammed until a falsified signal is generated and returned to confuse the observer; 2) tailored spectrum waveforms to fill open space but avoid co-site interference; 3) collision avoidance range-Doppler waveforms; and 4) optically mixed pre- or post-compensation of high BW phase distortions from high-gain RF antennas with poor intrinsic phase response.

THz applications are also anticipated. Examples of these extensions are THz signal generation and THz signal processing. Also, broadband RF, MMW, THz and optical signals could be applied for medical potential in finding reactions and the impact on human cells to different electrical impulses using various frequencies, waveforms, and designs.

An optical version of an AWG is as directly applicable to light wave circuitry as the analogs found in the ubiquitous counterparts for RF electronic circuits test bench equipment. Markets for existing electronic arbitrary waveform generators are large and expanding. According to Frost & Sullivan's market report, “World Signal Generators and Arbitrary Waveform Generators Markets” (released June 2008), there is a global market in which RF signal generators account for 52.6 percent of the 2007 revenues. Estimates increase for 2012, reflecting high growth rates in demand for AWGs with the increased development of higher performance instruments.

Commercial OAWGs do not exist, while electronic arbitrary waveform generators do, and have excellent performance with lower bandwidths, while still making excellent improvements over the past decade. As a point of comparison to what is currently available in the state-of-the-art high end AWG market place, Tektronix offers its AWG7102 product that offers approximately 4 GHz of bandwidth with about 6 effective number of bits (ENOB, a measure of the quality of a digitized signal). OAWGs for RF applications are anticipated to meet the needs of users with very wide bandwidths greater than about 10 GHz, and for optical applications with 10-1,000 GHz of bandwidth. The end users may be expecting RF generator performance, but will likely relax expectations in exchange for higher bandwidth.

### 7. Computational Hardware Overview

FIG. 11 is a block diagram that illustrates a computer system 1100 upon which an embodiment of the invention may be implemented. Computer system 1100 includes a communication mechanism such as a bus 1110 for passing information between other internal and external components of the computer system 1100. Information is represented as physical signals of a measurable phenomenon, typically electric voltages, but including, in other embodiments, such phenomena as magnetic, electromagnetic, pressure, chemical, molecular atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 1100, or a portion thereof, constitutes a means for performing one or more steps of one or more methods described herein.

A sequence of binary digits constitutes digital data that is used to represent a number or code for a character. A bus 1110 includes many parallel conductors of information so that information is transferred quickly among devices coupled to the bus 1110. One or more processors 1102 for processing information are coupled with the bus 1110. A processor 1102 performs a set of operations on information. The set of operations include bringing information in from the bus 1110 and placing information on the bus 1110. The set of operations also typically include comparing two or more units of information, shifting positions of units of information, and combining two or more units of information, such as by addition or multiplication. A sequence of operations to be executed by the processor 1102 constitute computer instructions.

Computer system 1100 also includes a memory 1104 coupled to bus 1110. The memory 1104, such as a random access memory (RAM) or other dynamic storage device, stores information including computer instructions. Dynamic memory allows information stored therein to be changed by the computer system 1100. RAM allows a unit of information stored at a location called a memory address to be stored and retrieved independently of information at neighboring addresses. The memory 1104 is also used by the processor 1102 to store temporary values during execution of computer instructions. The computer system 1100 also includes a read only memory (ROM) 1106 or other static storage device coupled to the bus 1110 for storing static information, including instructions, that is not changed by the computer system 1100. Also coupled to bus 1110 is a non-volatile (persistent) storage device 1108, such as a magnetic disk or optical disk, for storing information, including instructions, that persists even when the computer system 1100 is turned off or otherwise loses power.

Information, including instructions, is provided to the bus 1110 for use by the processor from an external input device 1112, such as a keyboard containing alphanumeric keys operated by a human user, or a sensor. A sensor detects conditions in its vicinity and transforms those detections into signals compatible with the signals used to represent information in computer system 1100. Other external devices coupled to bus 1110, used primarily for interacting with humans, include a display device 1114, such as a cathode ray tube (CRT) or a liquid crystal display (LCD), for presenting images, and a pointing device 1116, such as a mouse or a trackball or cursor direction keys, for controlling a position of a small cursor image presented on the display 1114, and issuing commands associated with graphical elements presented on the display 1114.

In the illustrated embodiment, special purpose hardware, such as an application specific integrated circuit (IC) 1120, is coupled to bus 1110. The special purpose hardware is configured to perform operations not performed by processor 1102 quickly enough for special purposes. Examples of application specific ICs include graphics accelerator cards for generating images for display 1114, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 1100 also includes one or more instances of a communications interface 1170 coupled to bus 1110. Communication interface 1170 provides a two-way communication coupling to a variety of external devices that operate with their own processors, such as printers, scanners and external disks. In general, the coupling is with a network link 1178 that is connected to a local network 1180 to which a variety of external devices with their own processors are connected. For example, communication interface 1170 may be a parallel port or a serial port or a universal serial bus (USB) port on a personal computer. In some embodiments, communications interface 1170 is an integrated services digital network (ISDN) card or a digital subscriber line (DSL) card or a telephone modem that provides an information communication connection to a corresponding type of telephone line. In some embodiments, a communication interface 1170 is a cable modem that converts signals on bus 1110 into signals for a communication connection over a coaxial cable or into optical signals for a communication connection over a fiber optic cable. As another example, communications interface 1170 may be a local area network (LAN) card to provide a data communication connection to a compatible LAN, such as Ethernet. Wireless links may also be implemented. Carrier waves, such as acoustic waves and electromagnetic waves, including radio, optical and infrared waves travel through space without wires or cables. Signals include man-made variations in amplitude, frequency, phase, polarization or other physical properties of carrier waves. For wireless links, the communications interface 1170 sends and receives electrical, acoustic or electromagnetic signals, including infrared and optical signals, that carry information streams, such as digital data.

The term computer-readable medium is used herein to refer to any medium that participates in providing information to processor 1102, including instructions for execution. Such a medium may take many forms, including, but not limited to, non-volatile media, volatile media and transmission media. Non-volatile media include, for example, optical or magnetic disks, such as storage device 1108. Volatile media include, for example, dynamic memory 1104. Transmission media include, for example, coaxial cables, copper wire, fiber optic cables, and waves that travel through space without wires or cables, such as acoustic waves and electromagnetic waves, including radio, optical and infrared waves. The term computer-readable storage medium is used herein to refer to any medium that participates in providing information to processor 1102, except for transmission media.

Common forms of computer-readable media include, for example, a floppy disk, a flexible disk, a hard disk, a magnetic tape, or any other magnetic medium, a compact disk ROM (CD-ROM), a digital video disk (DVD) or any other optical medium, punch cards, paper tape, or any other physical medium with patterns of holes, a RAM, a programmable ROM (PROM), an erasable PROM (EPROM), a FLASH-EPROM, or any other memory chip or cartridge, a carrier wave, or any other medium from which a computer can read. The term non-transitory computer-readable storage medium is used herein to refer to any medium that participates in providing information to processor 1102, except for carrier waves and other signals.

Logic encoded in one or more tangible media includes one or both of processor instructions on a computer-readable storage media and special purpose hardware, such as ASIC *˜20.

Network link 1178 typically provides information communication through one or more networks to other devices that use or process the information. For example, network link 1178 may provide a connection through local network 1180 to a host computer 1182 or to equipment 1184 operated by an Internet Service Provider (ISP). ISP equipment 1184 in turn provides data communication services through the public, world-wide packet-switching communication network of networks now commonly referred to as the Internet 1190. A computer called a server 1192 connected to the Internet provides a service in response to information received over the Internet. For example, server 1192 provides information representing video data for presentation at display 1114.

The invention is related to the use of computer system 1100 for implementing the techniques described herein. According to one embodiment of the invention, those techniques are performed by computer system 1100 in response to processor 1102 executing one or more sequences of one or more instructions contained in memory 1104. Such instructions, also called software and program code, may be read into memory 1104 from another computer-readable medium such as storage device 1108. Execution of the sequences of instructions contained in memory 1104 causes processor 1102 to perform the method steps described herein. In alternative embodiments, hardware, such as application specific integrated circuit 1120, may be used in place of or in combination with software to implement the invention. Thus, embodiments of the invention are not limited to any specific combination of hardware and software.

The signals transmitted over network link 1178 and other networks through communications interface 1170, carry information to and from computer system 1100. Computer system 1100 can send and receive information, including program code, through the networks 1180, 1190 among others, through network link 1178 and communications interface 1170. In an example using the Internet 1190, a server 1192 transmits program code for a particular application, requested by a message sent from computer 1100, through Internet 1190, ISP equipment 1184, local network 1180 and communications interface 1170. The received code may be executed by processor 1102 as it is received, or may be stored in storage device 1108 or other non-volatile storage for later execution, or both. In this manner, computer system 1100 may obtain application program code in the form of a signal on a carrier wave.

Various forms of computer readable media may be involved in carrying one or more sequence of instructions or data or both to processor 1102 for execution. For example, instructions and data may initially be carried on a magnetic disk of a remote computer such as host 1182. The remote computer loads the instructions and data into its dynamic memory and sends the instructions and data over a telephone line using a modem. A modem local to the computer system 1100 receives the instructions and data on a telephone line and uses an infrared transmitter to convert the instructions and data to a signal on an infrared a carrier wave serving as the network link 1178. An infrared detector serving as communications interface 1170 receives the instructions and data carried in the infrared signal and places information representing the instructions and data onto bus 1110. Bus 1110 carries the information to memory 1104 from which processor 1102 retrieves and executes the instructions using some of the data sent with the instructions. The instructions and data received in memory 1104 may optionally be stored on storage device 1108, either before or after execution by the processor 1102.

FIG. 12 illustrates a chip set 1200 upon which an embodiment of the invention may be implemented. Chip set 1200 is programmed to perform one or more steps of a method described herein and includes, for instance, the processor and memory components described with respect to FIG. *˜incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 1200, or a portion thereof, constitutes a means for performing one or more steps of a method described herein.

In one embodiment, the chip set 1200 includes a communication mechanism such as a bus 1201 for passing information among the components of the chip set 1200. A processor 1203 has connectivity to the bus 1201 to execute instructions and process information stored in, for example, a memory 1205. The processor 1203 may include one or more processing cores with each core configured to perform independently. A multi-core processor enables multiprocessing within a single physical package. Examples of a multi-core processor include two, four, eight, or greater numbers of processing cores. Alternatively or in addition, the processor 1203 may include one or more microprocessors configured in tandem via the bus 1201 to enable independent execution of instructions, pipelining, and multithreading. The processor 1203 may also be accompanied with one or more specialized components to perform certain processing functions and tasks such as one or more digital signal processors (DSP) 1207, or one or more application-specific integrated circuits (ASIC) 1209. A DSP 1207 typically is configured to process real-world signals (e.g., sound) in real time independently of the processor 1203. Similarly, an ASIC 1209 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1203 and accompanying components have connectivity to the memory 1205 via the bus 1201. The memory 1205 includes both dynamic memory (e.g., RAM, magnetic disk, writable optical disk, etc.) and static memory (e.g., ROM, CD-ROM, etc.) for storing executable instructions that when executed perform one or more steps of a method described herein. The memory 1205 also stores the data associated with or generated by the execution of one or more steps of the methods described herein.

### 8. Extensions and Modifications

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense. Throughout this specification and the claims, unless the context requires otherwise, the word “comprise” and its variations, such as “comprises” and “comprising,” will be understood to imply the inclusion of a stated item, element or step or group of items, elements or steps but not the exclusion of any other item, element or step, or group of items, elements or steps. Furthermore, the indefinite article “a” or “an” is meant to indicate one or more of the item, element or step modified by the article. As used herein, “substantively” means for purposes of a particular practical application.

### 9. REFERENCES

The following references are hereby incorporated by reference as if fully set forth herein except for terminology that is inconsistent with the terminology used herein.
[1] M. Hickey, R. Marsland, T. Day, “Generating Microwaves With Diode Lasers,” Lasers & Optronics, p. 15, July 1994.
[2] J. O'Reilly and P. Lane, “Remote Delivery of Video Services Using mm-Waves and Optics,” Journal of Lightwave Technology, v. 12, no. 2, p. 369, February 1994.
[3] Z. Jiang, D. E. Leaird, and A. M. Weiner, “Width and wavelength tunable optical RZ pulse generation and RZ-to-NRZ format conversion at 10 GHz using spectral line-by-line control,” IEEE Photon. Technol. Lett., v. 17, no. 12, pp. 2733-2735, December 2005.
[4] Z. Jiang, D. S. Seo, S.-D. Yang, D. E. Leaird, R. V. Roussev, C. Langrock, M. M. Fejer, and A. M. Weiner, “Four user, 2.5 Gb/s, spectrally coded O-CDMA system demonstration using low power nonlinear processing,” J. Lightwave Technol., v. 23, no. 1, pp. 143-158, January 2005.
[5] L. Mullen, A. Vierina, P. Herczfeld, and V. Contarino, “Application of RADAR Technology to Aerial LIDAR Systems for Enhancement of Shallow Underwater Target Detection,” IEEE Transactions on Microwave Theory and Techniques, v. 43, no. 9, pp. 2370-77, September 1995.
[6] A. M. Weiner, “Femtosecond optical pulse shaping and processing,” Progress in Quantum Electron., vol. 19, pp. 1-237, 1995.
[7] J. Chou, Y. Han, and B. Jalali, “Adaptive RF-Photonic Arbitrary Waveform Generator,” IEEE Photonics Tech. Lett. v. 15, p. 581, April 2003.
[8] S.T. Cundiff and A. M. Weiner, “Optical arbitrary waveform generation,” Nature Photonics, vol. 4, p. 766, November 2010, doi: 10.1038/nphoton.2010.196.
[9] S. A. Diddams et al., “Direct Link between Microwave and Optical Frequencies with a 300 THz Femtosecond Laser Comb,” Phys. Rev. Lett. v. 84, p. 5102 (2000).
[10] D. Miyamoto, K. Mandai, T. Kurokawa, S. Takeda, T. Shioda, and H. Tsuda, IEEE Photon. Technol. Lett. v. 18, p. 721 (2006).
[11] N. K. Fontaine, R. P. Scott, J. Cao, A. Karalar, K. Okamoto, J. P. Heritage, B. H. Kolner, and S. J. B. Yoo, Opt. Lett. v. 32, p. 865 (2007).
[12] Z. Jiang, D. E. Leaird, C. B. Huang, H. Miao, M. Kourogi, K. Imai, and A. M. Weiner, IEEE J. Quantum Electron. v. 43, p. 1163 (2007).
[13] Z. Jiang, D. E. Laird, A. M. Weiner, “Optical Arbitrary Waveform Generation and Characterization Using Spectral Line-by-Line Control,” J. Lightwave Tech. v. 24, p. 2487 (2006).
[14] N. K. Fontaine, D. J. Geisler, R. P. Scott, T. He, J. P. Heritage, S. B. Yoo, “Demonstration of high-fidelity dynamic optical arbitrary waveform generation,” Optics Express, vol, 18, p. 22993 (2010).

What is claimed is:

1. A method for producing a broadband arbitrary waveform, comprising:
storing a first waveform in a circulating coherent storage device;
generating a shifted replica by frequency shifting, by a frequency shift, the waveform in the circulating coherent storage device;
generating a next waveform; and
storing a combined waveform by coherently combining the shifted replica and the next waveform in the circulating coherent storage device.

2. A method as recited in claim 1, further comprising repeating the steps of generating the frequency shifted replica, generating a next waveform, and storing a combined waveform by coherently combining the shifted replica and the next waveform in the circulating coherent storage device.

3. A method as recited in claim 2, wherein each frequency shift is substantively equal to every other frequency shift.

4. A method as recited in claim 1, wherein generating the next waveform further comprises determining a spectrum and phase for the next waveform so that the combined waveform substantively matches at least a portion of a target broadband waveform.

5. A method as recited in claim 2, wherein generating the next waveform further comprises determining a spectrum and phase for the next waveform so that the combined waveform substantively matches at least a portion of a target broadband waveform.

6. A method as recited in claim 1, wherein the next frequency shift is about half as large as a bandwidth of the next waveform.

7. A method as recited in claim 1, wherein each of the next waveform and the first waveform is an optical waveform.

8. A method as recited in claim 1, wherein a frequency band of the next waveform is narrower than a frequency band of the combined waveform.

9. A method as recited in claim 1, further comprising directing the combined waveform to an output channel.

10. A method as recited in claim 7, further comprising:
directing the combined waveform to an output channel; and
converting an optical waveform on the output channel to a voltage.

11. An apparatus comprising:
means for storing a first waveform in a circulating coherent storage device;
means for generating a next waveform;
means for generating a shifted replica by frequency shifting, by a frequency shift, one of the next waveform or the waveform in the circulating coherent storage device; and
means for storing a combined waveform by coherently combining the shifted replica and one of the next waveform or the waveform in the circulating coherent storage device which is not frequency shifted.

12. A non-transitory computer-readable medium carrying one or more sequences of instructions, wherein execution of the one or more sequences of instructions by one or more processors causes an apparatus to:
determine a target broadband waveform;
determine a spectrum and phase for a first waveform in a circulating coherent storage device; and
determine a spectrum and phase for a next waveform,
wherein a frequency shifted replica of one of the first waveform or the next waveform coherently combined with one of the first waveform or the next waveform which is not frequency shifted generates a combined waveform that is stored in the circulating coherent storage device and that substantively matches at least a portion of the target broadband waveform.

13. An apparatus comprising:
at least one processor; and
at least one memory including one or more sequences of instructions,
the at least one memory and the one or more sequences of instructions configured to, with the at least one processor, cause the apparatus to perform at least the following:
determine a target broadband waveform;
determine a spectrum and phase for a first waveform in a circulating coherent storage device; and
determine a spectrum and phase for a next waveform,
wherein a frequency-shifted replica of one of the first waveform and the next waveform and a non-shifted waveform of the first waveform and the next waveform are coherently combined to generate a combined waveform that is stored in the circulating coherent storage device and that substantively matches at least a portion of the target broadband waveform.

14. An apparatus as recited in claim 13, further comprising.
a source of a carrier frequency waveform;
a modulator configured to impose the next waveform on the carrier frequency waveform;
a circulating coherent storage device configured to store a coherent interaction between multiple waveforms; and
a frequency shifter configured to generate a shifted replica by frequency shifting, by a frequency shift, one of the next waveform or a waveform in the circulating coherent storage device.

15. An apparatus comprising:
a source of a carrier frequency waveform;
a modulator configured to impose a next waveform on the carrier frequency waveform;
a circulating coherent storage device configured to store a coherent interaction between multiple waveforms; and
a frequency shifter configured to generate a shifted replica by frequency shifting, by a frequency shift, one of the next waveform or a waveform in the circulating coherent storage device.

16. An apparatus as recited in claim 15, wherein the circulating coherent storage device further comprises:
a phase correction component configured to correct phase of a waveform during each circulation in the circulating coherent storage device;
a delay path configured to delay a waveform during each circulation in the circulating coherent storage device;
an amplifier configured to compensate for attenuation in other portions of the circulating coherent storage device during each circulation in the circulating coherent storage device;
a first coupler configured to transfer the next waveform into the circulating coherent storage device; and
a second coupler configured to transfer a waveform out of the circulating coherent storage device

17. An apparatus as recited in claim 16, wherein the circulating coherent storage device further comprises an isolator configured to impose a single direction of circulation in the circulating coherent storage device.

18. A method for producing a broadband arbitrary waveform, comprising:
storing a first waveform in a circulating coherent storage device;
generating a next waveform;
generating a shifted replica by frequency shifting, by a frequency shift, one of the next waveform or the waveform in the circulating coherent storage device; and
storing a combined waveform by coherently combining the shifted replica and one of the next waveform or the waveform in the circulating coherent storage device which is not frequency shifted.
